(19) United States
(12) Patent Application Publication
(10) Pub. No.: US 2014/0257782 A1
(43) Pub. Date: Sep. 11, 2014

(54) SYSTEM AND METHOD FOR MEASUREMENT OF TEMPORAL CHANGES IN TRACE GAS FLUXES

(71) Applicants: Kenneth J. Davis, University Park, PA (US); Thomas Lauvaux, University Park, PA (US); Natasha L. Miles, University Park, PA (US); Scott J. Richardson, University Park, PA (US)

(72) Inventors: Kenneth J. Davis, University Park, PA (US); Thomas Lauvaux, University Park, PA (US); Natasha L. Miles, University Park, PA (US); Scott J. Richardson, University Park, PA (US)

(73) Assignee: THE PENN STATE RESEARCH FOUNDATION, University Park, PA (US)

(21) Appl. No.: 14/202,110

(22) Filed: Mar. 10, 2014

Related U.S. Application Data
(60) Provisional application No. 61/775,189, filed on Mar. 8, 2013.

(51) Int. Cl. G06F 17/50

(52) U.S. Cl. CPC G06F 17/5009
USPC 703/9

(57) ABSTRACT

Systems and methods are provided for estimating temporal changes in trace gas fluxes from a modifier of such trace gases. A method can include obtaining measurement amounts of trace gases from measurement sites in a region associated with the modifier. The method also includes computing modeled amounts of the trace gases based on an atmospheric transport model and prior estimates of trace gas flux from the modifier. The method further includes identifying corresponding portions of the measurement amounts and the modeled amounts associated with a time periods during which the spatial differences in measured amounts are predicted to be primarily due to the trace gas flux from the modifier. The method additionally includes selecting as a current estimate of the trace gas flux from the modifier a prior estimate associated with a difference between the corresponding measurement amounts and modeled amounts meet criteria.

### CROSS-REFERENCE TO RELATED APPLICATIONS

This application claims priority to and the benefit of U.S. Provisional Patent Application No. 61/775,189, filed Mar. 8, 2013 and entitled “SYSTEM AND METHOD FOR MEASUREMENT OF TEMPORAL CHANGES IN TRACE GAS FLUXES”, the contents of which are herein incorporated by reference in their entirety.

### FIELD OF THE INVENTION

The present invention relates to atmospheric modeling, and more specifically to apparatus and methods for measuring temporal changes in trace gas fluxes.

### BACKGROUND

Interest in quantifying greenhouse gas (e.g. CO₂, CH₄) sources and sinks, both biogenic and anthropogenic, is growing. The density of continuous tower-based greenhouse gas (GHG) mole fraction measurements is increasing in the United States and Europe. These measurements are deployed with the goal of using the data in inversion models to diagnose GHG fluxes.

Applications of these measurements has been limited to date mostly to continental to global scale atmospheric inversions. Few studies have attempted to infer fluxes from urban areas. A primary limit has been that measurement networks have typically been designed to detect large-area (e.g. continental scale or larger) fluxes. High-density urban GHG measurement networks are rare and costly. A second limit to progress in measuring urban emissions has been that atmospheric modeling is challenging over urban areas, as it requires simulation of the surface energy budget model in urbanized landscapes and atmospheric boundary layer (ABL) dynamics at high resolution. Urban plumes remain difficult to simulate correctly. An urban inversion system requires accurate adjoint modeling, good a priori information, and reliable uncertainties for the optimization system. Such a system would also likely require relatively high-density observations to constrain both the city emissions and the boundary inflow.

Accordingly, there exists a need to provide accurate estimates of emissions in various types of environments, and particularly in urban environments, utilizing relatively well-developed atmospheric modeling methods and simple, low to moderate cost observational networks.

### SUMMARY

Embodiments of the invention concern systems, methods, and computer-readable mediums for estimating temporal changes in fluxes of trace gases from a source or sink of such trace gases, i.e., a modifier. In a first embodiment of the invention, a method for estimating temporal changes in trace gas fluxes associated with trace gas modifier is provided. The trace gases can be at least one of CO, CO₂, or CH₄. The method includes obtaining measurement amounts of one or more trace gases for a plurality of measurement sites in a region associated with the modifier for a length of time. The method also includes computing modeled amounts of the trace gases at the plurality of measurement sites during the length of time based an atmospheric transport model and one or more prior estimates of a flux of the trace gases from the modifier. The method further includes identifying corresponding portions of the measurement amounts and the modeled amounts associated with at least one time period from the length of time during which the spatial differences in the measured trace gas amounts are predicted to be primarily due to the flux of the trace gases from the modifier. The method additionally includes selecting as a current estimate of the flux of the trace gases from the modifier one of the prior estimates associated with a difference between the corresponding portions of the measurement amounts and the modeled amounts meeting criteria.

In the method, the one or more prior estimates include a plurality of prior estimates, and the selecting can further include selecting as the current estimate one of the plurality of prior estimates for which the difference is smallest. Alternatively, the selecting can include selecting the current estimate to be any one of the one or more prior estimates for which the difference is less than a threshold difference. Responsive to none of the prior estimates resulting in a difference less than a threshold difference, the method can include repeating the computing, identifying, and selecting for at least one additional prior estimate of the flux of the trace gases from the modifier.

In the method, the identifying can further include selecting at least one period of time to correspond to a period of time for which atmospheric transport for the region can be simulated with at least a minimum degree of confidence.

In the method, the measurement amounts and the modeled amounts can be selected to correspond to amounts of the trace gases associated a plurality of different times of a day. Further, the measurement amounts and the modeled amounts can be selected to include a mixing ratio of the trace gases.

In a second embodiment, a system for estimating temporal changes in trace gas fluxes associated with trace gas modifier is provided. The system includes a processor a computer-readable medium having stored thereon a plurality of instructions for causing the processor to perform the methods above. In a third embodiment, a computer-readable medium is provided, having stored thereon a plurality of instructions for causing a computer to perform the methods described above.

### BRIEF DESCRIPTION OF THE DRAWINGS

FIG. 1 is a schematic illustrating components in a system for estimating GHG emissions in accordance with an embodiment of the invention;

FIG. 2, there is shown a flowchart of steps in an exemplary method for measuring temporal changes in trace gas fluxes due to GHG emissions from a source or sink of trace gases;

FIG. 3 shows the WRF-FDDA simulation domain topography, at the resolution of 1.3 km, with the mountain site and the downtown site identified, for obtaining an estimate of GHG emissions in accordance with an embodiment of the invention;

FIG. 4 shows the WMO surface observation distributions at 00 UTC, 29 Jan. 2012;

FIG. 5A shows a plot of observed CO₂ hourly mixing ratios in ppm at the downtown site, at the mountain site, and during well-mixed conditions;

FIG. 5B shows a plot of observed vs. modeled inter-site differences in CO₂ mole fraction;

FIG. 6 shows a plot of observed CH₄ hourly mixing ratios in ppm at the downtown site, at the mountain site, and during well-mixed conditions;

FIG. 7 shows daily CO2 emissions smoothed by 3-day running mean from December 23rd to February 29th and daily Heating Degree Days;

FIG. 8A and FIG. 8B shows diurnal cycles for CO2 and CO from the mountain top site and the downtown site;

FIG. 9 shows diurnal cycle composite of the CO/CO2 emission ratio as a function of time of day, for the time period before, during, and after the WEF; and

FIG. 10 shows observed and modeled—observed friction velocity over the study period.

FIG. 11 shows observed and modeled buoyancy flux over the study period.

FIG. 12 shows mean horizontal wind speed differences (modeled—observed) over the study period.

FIG. 13 shows observed and simulated 2-m potential temperatures during the study period.

FIG. 14 shows one exemplary system for carrying out the various embodiments of the invention.

### DETAILED DESCRIPTION

The present invention is described with reference to the attached figures, wherein like reference numerals are used throughout the figures to designate similar or equivalent elements. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operations are not shown in detail to avoid obscuring the invention. The present invention is not limited by the illustrated ordering of acts or events, as some acts may occur in different orders and/or concurrently with other acts or events. Furthermore, not all illustrated acts or events are required to implement a methodology in accordance with the present invention.

In view of the limitations of conventional systems, the various embodiments are directed to an urban scale inversion modeling system for estimating relative changes over time of greenhouse gas (GHG) emissions. In the various embodiments, an advanced data assimilation system can be used for the atmospheric transport and two or more surface towers are used for measuring GHG mixing ratios. Further, meteorological observations can be used to evaluate the model and GHG eddy-flux site to measure surface fluxes.

The core of the modeling system is the WRF model (available at http://www.wrf-model.org/index.php) coupled with Chemistry (WRF-Chem), modified for passive tracers. WRF-Chem can simulate the coupling among trace gas, aerosol, dynamics, radiation and chemistry. The WRF configuration for the model physics used here was based on previous numerical modeling studies using: 1) the single-Moment 3-class simple ice scheme microphysical processes, 2) the Kain-Fritsch scheme for cumulus parameterization on the 36- and 12-km grids, 3) the Rapid Radiative Transfer Model for longwave atmospheric radiation, and the Dudhia scheme for shortwave atmospheric radiation, 4) the TKE-predicting Mellor-Yamada Level 2.5 turbulent closure scheme (MY J PBL) for the boundary layer turbulence parameterization, and 5) the 5-layer thermal diffusion scheme for representation of the interaction between the land surface and the atmospheric surface layer.

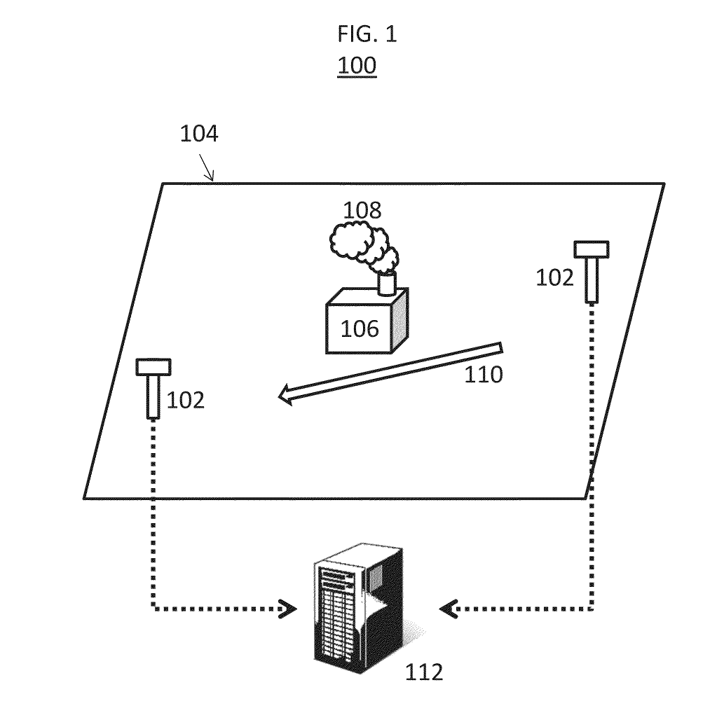

A basic configuration for using a modeling system in accordance with the various embodiments is illustrated with respect to FIG. 1.

FIG. 1 is a schematic illustrating components in a system 100 for estimating temporal changes in GHG emissions in accordance with an embodiment of the invention. The system 100 includes two or more measurement sites 102 positioned about a region of interest 104. Each of measurement sites 102 can be configured to measure amounts of trace gases. Such measurements can be obtained using any type of trace gas sensing systems and techniques. Further, although sites 102 are shown as towers, in other embodiments, the sites 102 can be attached to other structures, aircraft, or placed at naturally elevated positions. To estimate GHG emissions with respect to a source or sink (source/sink or modifier) 106 of GHG emissions 108, the measurement sites 102 can be positioned with respect to the direction of wind 110 typical for source/sink 106. In particular, at least one of measurement sites 102 can be positioned at a generally downwind position with respect to source/sink 106 and another of measurement sites 102 can be positioned at a generally upwind position with respect to source/sink 106.

Although FIG. 1 illustrates measurement sites 102 and source/sink 106 along a path substantially parallel to the direction of wind 110, the various embodiments are not limited in this regard. Rather, the positions of measurement sites can vary in the various embodiments. That is, any position can be used at which the downwind one of measurement sites 102 is likely to receive at least a portion of the GHG emissions 108. Further although only two measurement sites are illustrated in FIG. 1, any number of measurement sites can be used, upwind and downwind. In some embodiments, multiple sites can be used to enhance the modeling. Alternatively, the multiple sites can be provided so that they can be selectively utilized based on the direction of wind during particular time period. That is, a most downwind and most upwind site can be selected based on the wind direction during a period of time of interest.

The measurement sites 102 can be communicatively coupled to a computing device 112, which can then be used to estimate temporal changes in GHG emissions. The measurement sites 102 can be coupled to the computing device 112 via wireless communication links, wireline communications links, or a combination of both. Further, although computing device 112 is shown to be in direct communication with measurement sites 102, the various embodiments are not limited in this regard. Rather, in the various embodiments, the measurement sites 102 can be communicatively coupled to computing device 112 via one or more intermediate elements (not shown) communicating via one or more communications networks. Additionally, a persistent connection is not required in the various embodiments. That is, each of measurement sites 102 can include or can be affiliated with a different computing device for managing the measurement sites, including performing a storing measurement data from the measurement sites. Thus, the data can later be provided to computing device 112 to perform the necessary modeling. Accordingly, computing device 112 can be configured to perform the modeling in real-time or at a later time.

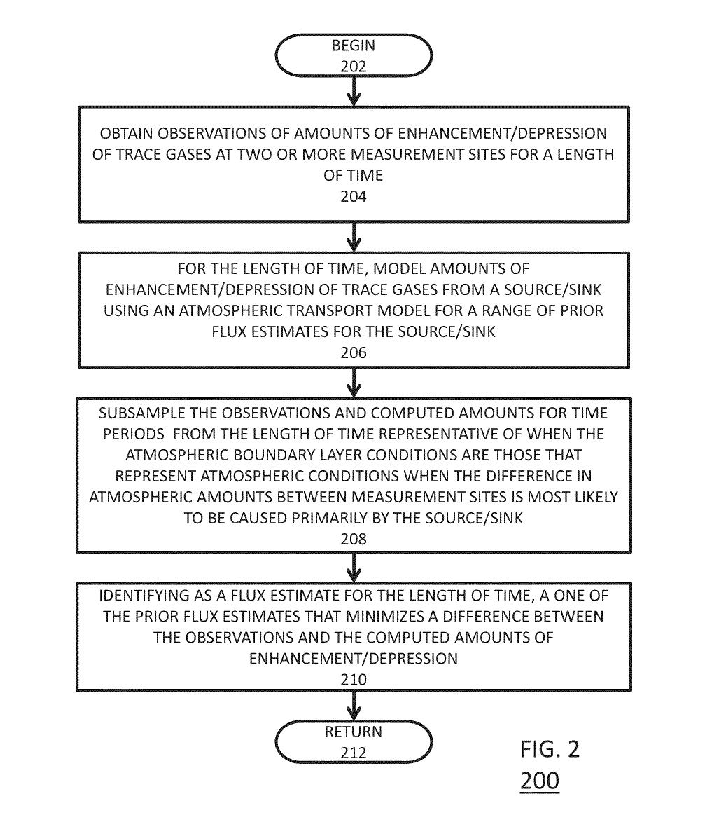

Now that a basic configuration of the measurement sites has been described, the disclosure turns to a more detailed description of the operation of computing device 112. Referring now to FIG. 2, there is shown a flowchart of steps in an exemplary method 200 for measuring temporal changes in trace gas fluxes due to GHG emissions from a source or sink, such as source/sink 106 in FIG. 1.

Method 200 begins at step 202 and continues to step 204. At step 204, observations or measurements of the amount of enhancement (or depression) in the trace gas mixing ratio in the atmospheric boundary layer, caused by fluxes of the trace gas from the source/sink of interest, are obtained. This measurement is performed for at least a length of time, if not continuously. In the various embodiments, measurements should represent temporally and/or spatially averaged conditions in the atmospheric boundary layer, but should resolve the daily cycle. That is, the measurements should preferably be averaged over no more than a few hours. Further, as noted above, the measurement sites can be carefully selected such that the measurements are obtained substantially upwind and downwind of the source/sink or interest.

Concurrently with step 204 or following step 204, the amount of enhancement or depression of the trace gas mixing ratio associated with a source/sink can be modeled at step 206 for the same length of time. In particular, an atmospheric transport model can be merged with a prior estimate of sources/sinks of the trace gas to compute an estimate the enhancement (or depression) in the trace gas mixing ratio in the atmospheric boundary layer caused by particular amounts of fluxes of the trace gas from the source/sink of interest during the length of time. In some embodiments, the merger of transport model and trace gas source/sink estimate is accomplished by running an atmospheric transport model that includes an equation for the conservation of the trace gas. The prior estimate of the trace gas source/sink is then included in the conservation equation for the trace gas. Thus at each time step of the atmospheric transport model, the prior estimate of the source/sink is used to add or remove a quantity of the trace gas from the atmosphere. The trace gas is added at a particular point in space (often the lowest layer of atmosphere simulated by the atmospheric transport model) as dictated by the prior flux estimate. The spatial and temporal pattern of the source/sink is used as part of the prior estimate and therefore may vary as is appropriate for the situation. For example, there may be constant emissions from within the boundaries of a city but no emissions from the surrounding countryside.

The flux estimate may or may not vary as a function of the atmospheric conditions predicted by the atmospheric model (that is, the prior flux estimate may be run in a coupled or offline mode). Multiple prior flux estimates can be simulated simultaneously, resulting in a range of possible modeled atmospheric mole fractions at the observation sites. For example, the prior flux estimate can be increased or decreased by a spatially constant multiplicative factor, resulting in a simulation of the change in modeled atmospheric mole fraction at the observing sites in response to such a change in the prior flux.

In the various embodiments, an atmospheric model transport model is used that is able to simulate atmospheric transport in three dimensions with realistic initial conditions and boundary conditions for the region of interest, where the spatial and temporal resolution that is high enough to resolve atmospheric transport that most relevant for the region of interest. This can include, for example, sufficient temporal resolution to capture the day/night cycle of boundary layer mixing and sufficient spatial resolution to capture the influence of local topography on mesoscale mean wind patterns. In some embodiments, a mesoscale numerical weather prediction model, such as the Weather Research and Forecasting model (WRF, http://www.wrf-model.org/index.php) can be used. To use such a model, boundary and initial conditions for the model can be gathered from an atmospheric reanalysis product, such as one of the products provided operationally by the National Centers for Environmental Prediction (NCEP).

As noted above, the amounts of enhancement or depression in trace gas mixing ratio are computed at step 206 for a range of prior flux estimates. Thus, it is possible in order to obtain a function that describes the amount of enhancement and depression of trace gas ratio as a function of the source/sink strength. Accordingly, the result of step 206 is a collection of modeled enhancement/depression amounts for the length of time, but for different flux estimates.

Once the observed and modeled amounts of enhancement or depression in trace gas mixing ratio are obtained at steps 204 and 206, respectively, the method can proceed to step 208. At step 208, the amounts obtained at steps 204 and 206 are subsampled. In particular, the amounts subsampled are those corresponding to time periods when the atmospheric boundary layer conditions are those that represent atmospheric conditions when the difference in atmospheric mole fractions between measurement sites is most likely to be caused primarily by the sources and sinks of interest. Further, the time periods are preferably selected to correspond to those that are able to be simulated relatively well by the atmospheric transport model.

In general, conditions that numerical models can simulate easiest are conditions where the lower atmosphere (the atmospheric boundary layer) is relatively well-mixed by turbulence. Thus either by direct observation of the turbulence or by knowledge of the meteorological conditions typically associated with stronger mixing, one can select well mixed atmospheric conditions. Over land, the most common time to find strong turbulent mixing of the atmospheric boundary layer is midday/early afternoon. Accordingly, the time periods can be selected in step 208 in a variety of ways. In some embodiments, the time periods can be selected a priori by the user. In other embodiments, a set of default time periods can be selected. In still other embodiments, turbulence data can be analyzed. Thus, the time periods can be selected from those in which the turbulence data meets some criteria. These methods are presented solely for purposes of illustration, not by way of limitation. Accordingly, other methods of selecting time periods can also be used in the various embodiments. Additionally, a combination of methods can also be used in the various embodiments.

Once the amounts are subsampled at step 208, the subsampled amounts can be compared. For example, for the selected time periods, the difference in modeled versus measured amounts of enhancement or depression in the trace gas mixing ratio in the atmospheric boundary layer, caused by fluxes of the trace gas from the source/sink of interest, can be computed or otherwise obtained as a function of the prior flux estimate. Subsequently, at step 210, the prior flux that minimizes the difference in atmospheric boundary layer trace gas mixing ratio enhancement/depression between the amounts obtained at step 204 and the modeled amounts from step 206 can be identified as the best estimate of the regional trace gas source/sink for that given time period. The method 200 can then resume previous processing at step 202, including repeating method 200. For example, the method can be repeated to obtain flux estimates for various lengths of time and these estimates can be combined to show temporal variability in the flux over any period of time of interest.

In the various embodiments, the method can be applied to a time domain that ranges from less than an hour to many days. Further, the spatial resolution of the flux estimate can be adjusted within this time domain.

In an alternate configuration of the method, an iterative process can be utilized. That is, at step 206, modeled amounts can be computed for a single prior flux estimate. Then, after the subsampling at step 208, instead of selecting an amount that minimizes a difference, the difference obtained for the currently prior flux estimate can be evaluated with respect to criteria. If the criteria are met, the prior flux estimate from step 206 is identified as the flux estimate for the source/sink. If the criteria are not met, the steps can be repeated for different prior flux estimates until the criteria are met.

In the various embodiments, the range of prior flux estimates for step 206 can be selected in a variety of ways. In some embodiments, there may be several flux values available for which there is a high degree of confidence. These may be associated with different regions with similar sources/sinks or similar geographical or meteorological conditions, different times for the region of interest, or any other features having some relation to the region of interest, the meteorological conditions therein, and/or the source/sink of interest. These data points may have been obtained via a model or empirical means. Regardless of the source of the data points, the estimates can be interpolated. In some cases, a simple linear interpolation will suffice. However, in other cases, the relationship may not be a direct or straightforward. In such cases, it may be necessary to utilize a more sophisticated interpolation, especially in the case of complex spatial structures.

As to the range of values selected for the prior flux estimates, the breadth of the range can be selected based in a variety of ways. For example, if there is a high degree of confidence in how the flux varies, a smaller range of values can be selected. In contrast, if there is greater uncertainty in the variation, a large range can be selected. Alternatively, the range can be selected based on how close the prior estimate is believed to be with respect to the actual flux. Thus, if there is a high degree of confidence in that the estimate flux will be close to the actual flux is, a smaller range of values can be selected. In contrast, if there is greater uncertainty, a large range can be selected.

In some embodiments, the method of FIG. 2 can be extended to quantify the absolute magnitude of the flux. As noted above, the methodology of FIG. 2 does result in an estimate of the absolute magnitude of the flux of the trace gas from the source/sink of interest. Rather, the accuracy of the magnitude of that estimate is questionable to the point of being inappropriate to use to quantify the absolute magnitude of the flux. In the various embodiments, the accuracy of the magnitude of the flux can be improved to the point of being an appropriate measure of the magnitude of the flux. In particular, such an improvement is possible evaluating the accuracy of two key characteristics of the atmospheric transport model, the wind speed and direction within the atmospheric boundary layer and the depth of the atmospheric boundary layer.

Thus to extend the method illustrated in FIG. 2 to a more accurate estimate of the magnitude of the flux, one must first obtain measurements or other trustworthy, independent estimates of the wind speed and direction within the atmospheric boundary layer, and the depth of the atmospheric boundary layer. These measurements are then compared to the winds and boundary layer depth simulated by the atmospheric transport model.

At this point, two analysis paths are possible. First, the atmospheric transport model can be modified so that the discrepancy between the modeled and observed boundary layer winds and boundary layer depth is minimized or brought to within an acceptable threshold. The level of discrepancy that is acceptable may be dependent upon the need for accuracy in the flux estimate. Second, the atmospheric transport model can be unchanged, but the difference between the observed and modeled boundary layer winds can be used to estimate a bias that is introduced into the flux estimate using boundary layer budget methods. This bias can then be removed from the flux estimate to provide the improve flux estimate.

Although the various embodiments have been described generally with respect to the estimation of flux of GHG's (e.g., CO₂, and CH₄), the various embodiments are not limited in this regard. Rather, the methods and systems described herein can also be used for purposes of evaluating monitoring any other types of gases. Thus, the term “trace gases” can refer to any gas of interest.

### EXAMPLES

The following examples and results are presented solely for illustrating the various embodiments and are not intended to limit the various embodiments in any way.

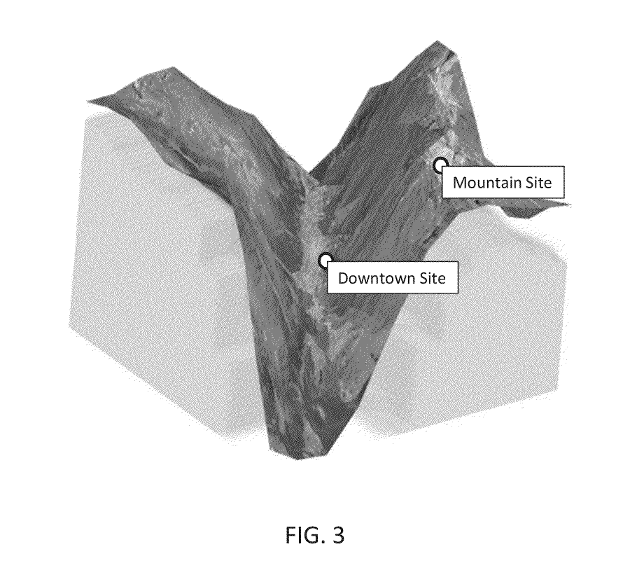

To evaluate the modeling system described above, an analysis of the here daily emission estimates using a mesoscale atmospheric inversion system over the city of Davos, Switzerland, before, during, and after the World Economic Forum 2012 meeting (WEF) was performed. Two instruments measuring continuously atmospheric mixing ratios of Green House Gases (GHG) were deployed at two locations from late December 2011 to February 2012, one site being located in the urban area and a second out of the valley in the surrounding mountains. Carbon dioxide, methane, and carbon monoxide were measured continuously at both sites. Additionally, a flux analyzer was deployed in the city to evaluate the inverse flux estimates. The configuration for this study is illustrated in FIG. 3. FIG. 3 shows the WRF-FDDA simulation domain topography at the resolution of 1.3 km, with the mountain site and the downtown site identified.

The mesoscale atmospheric model WRF-ARW, in Four-Dimensional Data Assimilation (FDDA) Mode, was used to simulate the transport of GHGs over the valley of Davos at 1.3 km resolution. The WRF modeling system that was used in this study has four-dimensional data assimilation (FDDA) capabilities to allow meteorological observations to be continuously assimilated into the model. The FDDA technique used in this study was originally developed for MM5 and recently implemented into WRF. The WRF system used herein has been used in several studies. Nudging of the wind field is applied through all model layers, but nudging of the mass fields (temperature and moisture) is only allowed above the model-simulated PBL so that the PBL structure produced by the model is dominated by the model physics. In this specific real-time study, World Meteorological Organization (WMO) observations were assimilated into the WRF-Chem system to produce a dynamic analysis, blending the model simulations and the observations to produce the most accurate meteorological conditions possible to simulate the atmospheric CO₂ concentrations in space and time throughout the Davos region.

The WRF model grid configuration used for this study consists of four grids: 36-km, 12-km, 4-km and 1.33-km, all of which are co-centered at Davos, Switzerland. The 36-km grid, with a mesh of 110×110 grid points, contains the entire continental Europe, and parts of the Atlantic Ocean. The 12-km grid, with a mesh of 151×151 grid points, contains France, Italy, Poland and Germany. The 4-km grid, with a mesh of 175×175 grid points, contains western France, southern Germany, northern Italy, western Austria and all of Switzerland. The 1.33-km grid, with a mesh of 202×202, covers portions of northern Italy, southern Germany, western Austria and western Switzerland, with the grid centered at Davos. 50 vertical terrain-following layers are used, with the center point of the lowest model layer located 12 m above ground level (AGL). The thickness of the layers increases gradually with height, with 27 layers below 850 hPa (1550 m AGL).

The FDDA parameters used in this application can be found in Deng et al. (2012). For this study, 3D analysis nudging and surface analysis nudging were applied on both the 36- and 12-km grids with reduced nudging strength (G) on the 12-km grid, and observation nudging was applied on all grids with the same nudging strength. No mass fields (temperature and moisture) observations are assimilated within the WRF-predicted PBL. The meteorological observations assimilated into the WRF system are based on the World Meteorological Organization (WMO) observations distributed by the National Weather Service (NWS), and include both 12-hourly upper-air rawinsondes and hourly surface observations.

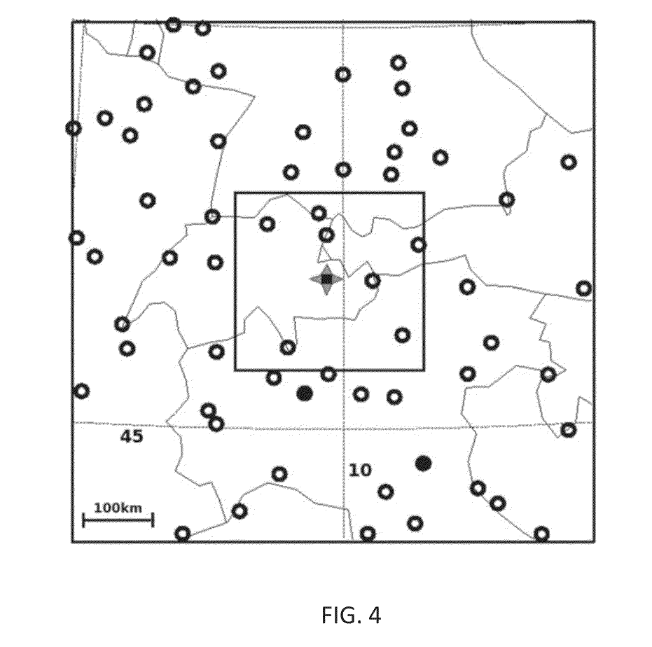

FIG. 4 shows the WMO surface observation distributions at 00 UTC, 29 Jan. 2012, on the 4- and 1.33-km grids, indicating a significant number of observations over the region. The gridded meteorological data needed to initialize the WRF-Chem real-time system was obtained from the National Centers for Environmental Prediction (NCEP) Global Forecast System (GFS) analyses (i.e., zero-hour forecast), available 6-hourly in real-time.

### Prior Emissions: Modified 2005 Inventories

The inventory, or initial estimate of CO₂ emissions in Davos, consists of one single number for the year 2005. Direct emissions (as opposed to indirect emissions from manufacturing or activities emitting carbon out of the valley) represent 91% of the 106 kilo-tons of CO₂ emitted per year, which correspond to 8-9 tCO₂ per capita annually. House heating emissions alone represent 76% of the direct CO2 emissions, followed by traffic (17%), and other sources such as machines, or electricity, for about 7%.

House heating emissions originate from the combustion of fuel oil at 98.5%, whereas electricity, thermal heating, wood, geothermal, and natural gas represent only 1.5%. Similarly, human respiration from the city represents about 3% of the total direct emissions based on the population of about 12 000 people and using a human respiration factor.

Although the inventory provides annual emission estimates for each energy source, no spatial or seasonal references are available. To correct for the seasonal variability, the first month of the experiment was used as a correction period, with a large increase due to house heating in winter time. The correction may also include potential changes in the emissions between the years 2005 and 2012. Results are presented below. For the spatial distribution, the inventories account for emissions at the county scale of Davos, with a total surface of about 254 km² Only 6 km² (or about 2%) of the total area corresponds to a low density urban area. The land cover map from USGS (Land Cover Map classification used in WRF) was used to distribute the county level emissions in space, using pixels dominated by the low density residential land cover type. At 1.33 km resolution, three pixels represented the source area in the prior flux estimate.

### Inversion Technique: Direct Interpolation (Adjoint-Free)

The first guess used in the inversion was also limited to the three urban pixels due to the absence of other anthropogenic sources in the near valley and the dormance of the surrounding vegetation with the low wintertime temperatures. In this context, the inverse system was developed to estimate daily CO₂ emissions from the whole city, not spatially resolved. For the same reason, the inverse system did not require the use of an adjoint model, considering that the spatial distribution of the sources was not explicitly described. Only the direct model WRF was used to simulate the transport and applied a linear interpolation based on the CO₂ atmospheric mixing ratio residuals that were propagated to the emissions.

The initial relationship between the atmospheric mole fraction and the emissions was determined using three scenarios. The WRF-FDDA model was first coupled to the initial emission estimate from the literature, then a 20% increase in the emissions was added, and then a last run was made with a 40% increase. The linear coefficient a was determined using the following relationship:

$$\frac{{[ {CO}_{2} ]}_{X}}{{[ {CO}_{2} ]}_{prior}} = α \frac{{F}_{X}}{{F}_{prior}} , \qquad ( 1 )$$

where F_{X} represents the prior daily fluxes increased by X %, Fₚᵣᵢₒᵣ represents the prior emissions from the literature, [CO₂]_{X} is the modeled CO₂ mole fraction from WRF at the downtown site location using F_{X}, and [CO₂]ₚᵣᵢₒᵣ is the modeled CO₂ mole fraction from WRF at the downtown site location using Fₚᵣᵢₒᵣ. The value of a was determined from this equation and was applied to interpolate the daily emission corrections using the following equation:

$$\frac{{F}_{{CO}_{2}}}{{F}_{prior}} = \frac{1}{α} \frac{{[ {CO}_{2} ]}_{WRF}}{{[ {CO}_{2} ]}_{Downtown} - {[ {CO}_{2} ]}_{bckgd}} , \qquad ( 2 )$$

where F_{CO2} represents the posterior daily fluxes, Fprior represents the prior emissions from the literature, [CO₂]_{WRF} is the modeled CO₂ mole fraction from WRF at the downtown site location, [CO₂]Downtown is the observed CO₂ mole fraction at the downtown site, and [CO₂]_{bckgd} is the observed CO₂ mole fraction at the mountain site (background). The observed mole fractions used in the inverse system correspond to the site-to-site hourly differences during well-mixed conditions, as discussed below. Daytime afternoon mole fractions were selected for only the inversion [1200-1700 local time (LT)]. Other criteria were used (e.g., threshold value in friction velocity) that showed similar results for the definition of the measurement periods.

The mountain site provided the CO₂ inflow (background mixing ratios) that was removed from the downtown mixing ratios. The use of a background observation site in addition to the downtown site provided a unique set of atmospheric observations in which other potential source signals have been removed. No boundary inflow was then required in the inverse system.

This method also assumes a perfect transport model and excludes the use of uncertainties for prior fluxes or transport. Whereas potential model errors may affect daily inverse estimates due to the absence of explicitly described model errors in the inversion, an optimal period of observation was determined based on a well-mixed criteria. Evaluated were the atmospheric model simulations using meteorological measurements, and selected were the optimal time period to ensure the well-mixed conditions in the PBL. These results are presented below.

Similar to the ABL budget approach, here the model data residuals were used directly to estimate the daily emission corrections (multiplicative factors), which are applied to the initial emission estimate. The mismatch between the modeled mixing ratios and the observed mixing ratios was directly applied to the daily emissions. The use of the FDDA system allows one to simulate the full complexity of the atmospheric circulation and dynamics at the local scale, which is more robust than ABL budget approaches using idealized box models or the differential of mixing and concentrations. Three scenarios were performed daily, all based on the initial inventory estimate, to evaluate the transport linearity assumption. The first scenario used the initial estimates described above, a second scenario with a +20% increase compared to the initial estimate, and a third scenario at +40%. A linear regression technique was used to interpolate the mixing ratio mismatch to the emissions, using observations during well-mixed conditions only. The well-mixed conditions were defined by direct flux measurements. The daily corrections were computed using hourly mixing ratio site-to-site differences compared to the directly modeled results.

### Results

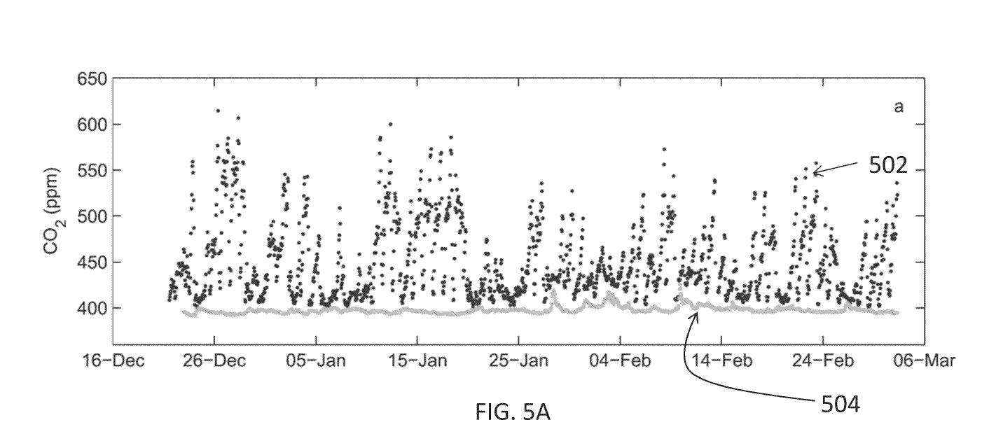

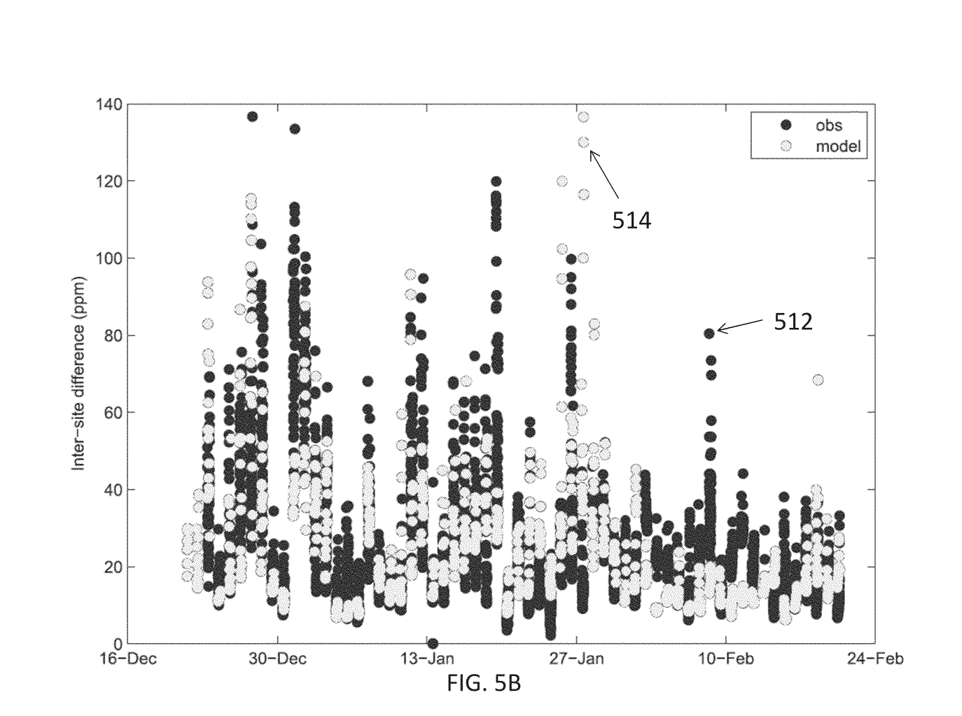

The observed CO₂ atmospheric mixing ratios are presented in FIG. 5A at the hourly time scale. FIG. 5A shows a plot of observed CO₂ hourly mixing ratios (ppm) at the downtown site (502) filtered with a minimum value of 0.3 ms21 of friction velocity for well-mixed conditions and at the mountain site (504). The downtown site observations (502) show a large diurnal cycle, with high peaks during night time, and lower values during daytime. The large amplitude of the diurnal cycle is due to the changes in stability conditions in the valley of Davos, from stable to unstable, despite the low temperature in winter. The CO₂ emitted in Davos accumulates in the valley, with peaks of up to 250 ppm compared to the background mixing ratios. Mixing ratios observed at the mountain site (504) are systematically lower than at the downtown site, confirming the assumption of background air at the mountain site and the absence of local pollution sources. The low variability at the mountain site shows the absence of other sources in the area, despite three minor events which correspond to elevated mixing ratios at the downtown site. These three events may correspond to synoptic events transporting air masses with elevated CO₂ from other parts of Europe. The site-to-site mixing ratio differences are shown in FIG. 5B. FIG. 5B. shows Observed (512) and modeled (514) intersite mole fraction differences (ppm) between the downtown site and the mountain site filtered using the friction velocity criteria (daytime values only). Modeled mole fractions were simulated at 1.33-km resolution by the WRFFDDA modeling system coupled to the constant prior emissions used in the inverse study. The site-to-site mixing ratio differences show no correlation with temperature, and are strongly influenced by the local atmospheric dynamics. The importance of the ABL dynamics (vertical mixing and ABL depth) in the valley require the use of the high resolution modeling system to extract emission signals in the observed atmospheric mixing ratios.

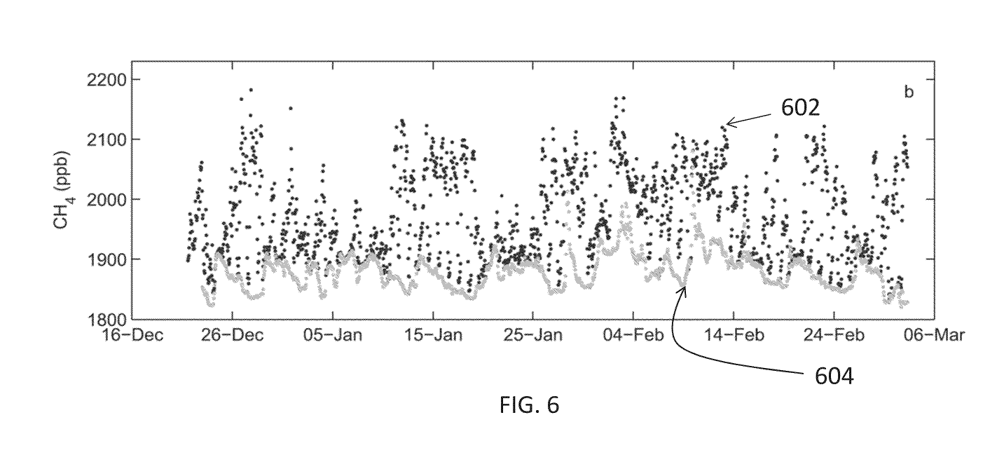

The atmospheric CH₄ mixing ratios were not used in the inverse system but are presented in FIG. 6 as a distinct GHG emitted from different local and distant sources. In particular, FIG. 6 shows observed CH₄ hourly mixing ratios (ppm) at the downtown site (602) filtered with a minimum value of 0.3 ms21 of friction velocity for well-mixed conditions and at the mountain site (604). Compared to the observed CO₂ mixing ratios, the background mixing ratios are highly variable at the mountain site. The minimum values at the downtown site remain systematically higher than the mountain site. But other sources out of the valley of Davos are contributing to the observed variability, located within the surrounding valleys. Potential sources of methane in the area may include primarily farming, but also waste water treatment plants, landfills, or leaks in the distribution network or during the combustion. Considering the amplitude of the signals and no major city in the area, the most likely source of CH₄ is farming, with cattle kept in barns during winter, most of them being located in the valleys. No clear correlation was found between the wind direction and the peaks, indicating several nearby sources in different directions. Similar to the CO₂ mixing ratios, the diurnal amplitude at the downtown site is large (about 200 ppbv) and daytime periods correspond clearly to low mixing ratios. Urban emissions of CH4 within Davos include farming as well as waste water treatment, and traffic, responsible for high mixing ratios during nighttime at the downtown site (up to 2,200 ppbv).

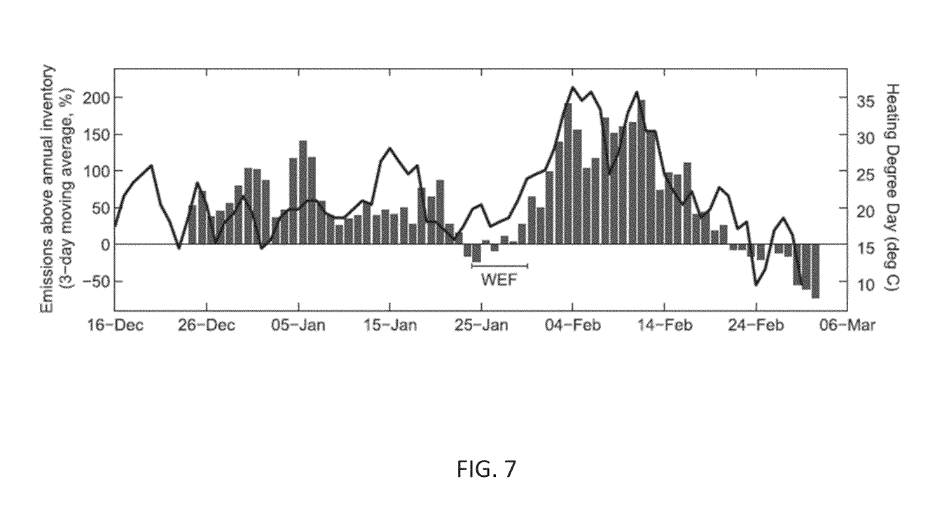

As noted above, the intersite differences for the observed and the modeled mole fractions are presented in FIG. 5B using the friction velocity criteria. The day-to-day variability is about 15 ppm, with maximum observed differences of about 100 ppm. The interpretation of modeled versus observed intersite mole fraction differences is limited by the large variability, with the exception of the month of February, which shows a clear underestimation of the simulated atmospheric mole fractions. The daily estimates of CO₂ emissions relative to the prior flux estimate, computing using the approach indicated in FIG. 2, are presented in FIG. 7 (black bars) along with the Heating Degree Days (HDD, gray background) which represents the difference between the outdoor and typical indoor air temperatures. Each bar in FIG. 7 represents the results one iteration of the method of FIG. 2. The instruments measuring the atmospheric mixing ratios of GHGs were deployed from Dec. 23, 2011 to Feb. 29, 2012. During the first half of the deployment, the outdoor temperature was close to the climatological average (average temp before WEF minus climatology). During the second half, a cold wave affected a large part of Western Europe, more severely Central and Eastern Europe, as well as North Africa and Western Asia, starting in January 27 until February 17. The 2012 cold wave in February was exceptional, especially in France, Switzerland and Germany, being one of the ten most intense events in Zurich since 1864. In Davos, the minimum temperature reached −24.5° C. on February 4 (WMO station, Davos, WMO_ID=6784). Finally, during the last days of the campaign, the temperature increased with a corresponding HDD of less than 15° C. (starting from February 20).

The initial annual inventory estimate was calibrated during the first month of the campaign, before the WEF 2012 meeting. Daily emissions were 40% above the initial estimate on average over the month of January. This first estimate is used to provide a corrected value for the 2012 winter season. Over the two months of the campaign, the corresponding daily emissions from the atmospheric inverse system are highly correlated with the HDD, which is consistent with the contribution of house heating from the initial inventory (76% of the total direct emissions). The contribution from house heating and traffic are presented in the next section using the CO/CO₂ emission ratio. The maximum of daily emissions occurred during the maximum of intensity of the cold wave, during which the daily emissions more than doubled for a week. During the WEF 2012 meeting, before the start of the cold wave, the inverse daily emissions decreased by 35% compared to emissions in January, despite similar temperatures. Finally, the last period of the deployment (starting in February 20) showed a decrease in the daily emissions, as the RDD decreased and reached its minimum over the entire campaign.

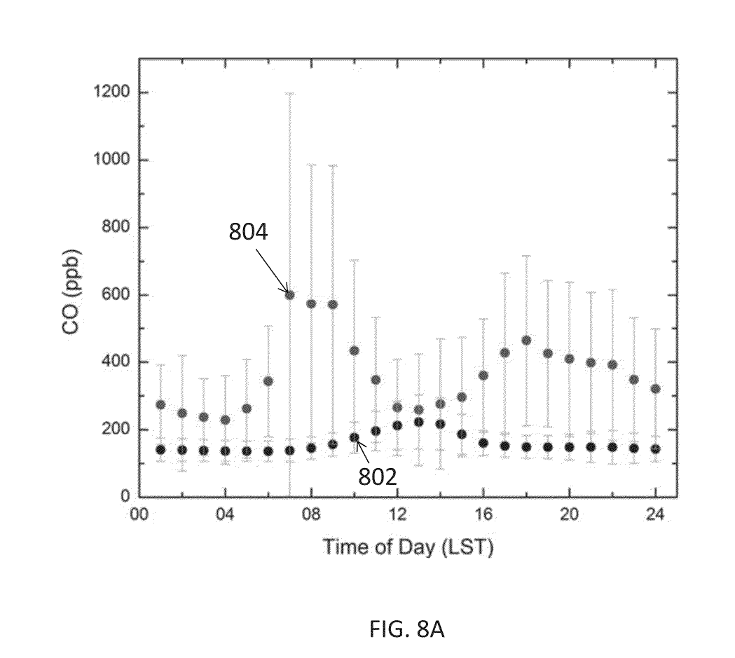

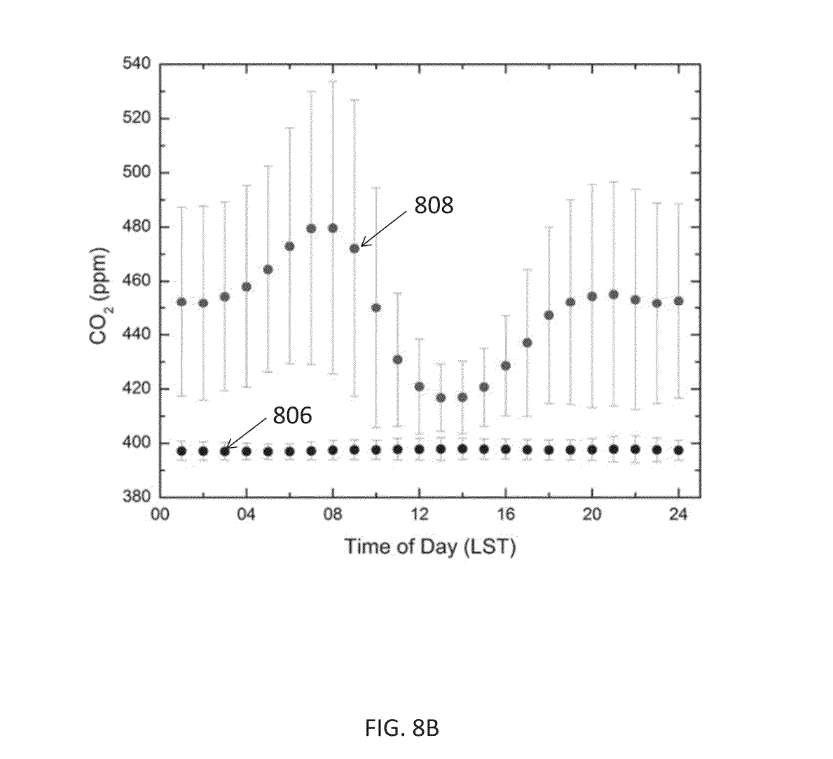

Both sites measured carbon monoxide (CO) continuously in addition to CO₂ and CH₄ used to generate diurnal cycles at hourly resolution, composites of three distinct periods: before, during, and after the WEF meeting. The diurnal cycles are shown in FIGS. 8A and 8B for CO and CO₂, respectively, from the mountain top site (802, 806) and the downtown site (804, 808). Whereas the downtown CO₂ signal reveals a clear and pronounced diurnal cycle indicating the presence of local pollution sources, the mountain top site shows almost no variability during the day, indicating that all the variability in CO₂ observed at the mountain top site is from more distant sources, along with variability in the background. Therefore, the enhancement in carbon dioxide observed in the urban site is well represented by simply subtracting the mountain site from the urban site.

The CO diurnal cycle at the downtown site (FIG. 8B) shows two distinct peaks (morning and afternoon) correlated with the CO₂ cycle. The mountain site cycle shows a strong enhancement around mid-day, with a CO enhancement of about 80 ppbv above the nocturnal baseline. The absence of concurrent enhancement of CO₂ in FIG. 8A may correspond to a local source with a very high CO/CO₂ ratio, potential photochemical production of CO from VOCs in the atmosphere, combined with the valley circulation with upwelling of polluted air from Davos. Other sources of CO in the area may have contributed to the observed CO enhancement, for example, Arosa, located southwest of the mountain site in a large valley. This absence of CO₂ enhancement also indicates that the mountain site cannot be used as a background signal for the urban enhancement during the mid-day hours. For the analysis, the minimum CO value observed at the mountain top site within a given 24 hour period will be used as the baseline value for CO for the urban site.

According to the literature, local direct emissions sources to Davos include no significant power generation facilities, and limited industrial activity. On a yearly basis, about 17% of the direct CO₂ emissions are due to road transit, and 75% from fossil fuel driven heating. Given that the estimates are yearly, the emissions for both transit and heating will vary during the year due to changing weather and tourist populations. Further, these emissions will not be distributed uniformly over the day. Consumption of fossil fuel for heating will be driven primarily by ambient temperature, and will be greatest during the late night and early morning hours. Transit emissions will be greatest during the daylight hours, and will drop dramatically in the middle of the night when there is very little traffic on the roads. The heating sources also vary substantially in their CO/CO₂ emission ratio, from 0.05 to 0.6 ppbv_{CO}/ppmv_{CO2}, for fuel oil furnaces. Emissions factors for residential gas appliances (furnaces, space heaters, water heaters, range burners, and ovens) varied from 0.25 ppbv_{CO}/ppmv_{CO2}, for water heaters to 3.5 ppbv_{CO}/ppmv_{CO2}, for range burners. Conversely, mobile combustion sources like cars and trucks tend toward higher emissions ratios from 9 to 35 ppbv_{CO}/ppmv_{CO2}. However, mobile sources show higher CO/CO₂ emissions ratios than fixed fossil fuel combustion sources.

According to the literature, local direct emissions sources to Davos include no significant power-generation facilities and limited industrial activity. On a yearly basis, about 17% of the direct CO₂ emissions are from road transit and 76% are from fossil fuel-driven heating. Although the estimates are yearly, the emissions for both transit and heating will vary during the year because of changing weather and tourist populations. Further, these emissions will not be distributed uniformly over the day. Consumption of fossil fuels for heating will be driven primarily by ambient temperature and will be greatest during the late night and early morning hours. Transit emissions will be greatest during the daylight hours and will drop dramatically in the middle of the night when there is very little traffic. The heating sources also vary substantially in their CO/CO₂ emission ratio, with estimates by the U.S. Environmental Protection Agency of 0.3 ppbCO/ppmCO₂ for fuel oil furnaces and 0.5 ppbCO/ppmCO₂ for natural gas furnaces. Emissions factors for residential gas appliances (furnaces, space heaters, water heaters, range burners, and ovens) vary from 0.24 to 3.3 ppbCO/ppmCO₂ using a CO₂ emission factor for natural gas of 50 300 ng CO₂ J⁻¹. The literature similarly indicate an emission factor for residential heating of 2.4 ppbCO/ppmCO₂. Conversely, mobile combustion sources like cars and trucks tend toward higher emissions ratios. The literature indicates that a typical emission ratio for the German transit fleet is 17.2 to 24.1 ppbCO/ppmCO₂ emitted. The literature also indicate that the emission ratio for the traffic fleets in several U.S. cities range from 9 to 37 ppbCO/ppmCO₂. Although these ranges are large, the ratios are all much larger than the low values expected for residential heating.

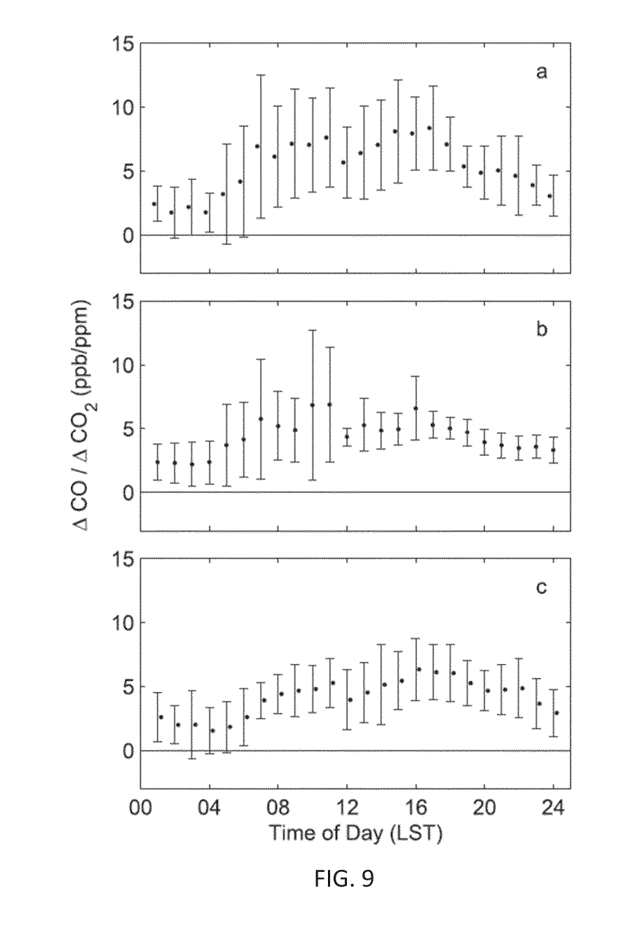

FIG. 9 shows the observed CO/CO₂ ratio diurnal cycle composite for the three different periods (a—before, b—during, c—after the WEF-2012). The ratio is much lower in the late night and early morning hours than it is during the daylight hours. The signal between 0.0 and 0.25 days averages about 2.5 ppbvco/ppmvco₂. This is consistent with the interpretation that the CO₂ signal arises primarily from heating during the daylight hours. The CO/CO₂ ratio is highest during the day, consistent with a mixed signal between heating and road transit. The daytime ratio is about 6.3 ppbvco/ppmvco₂. As this ratio is between the typical values for heating and road transit, the observed values show that the daytime emissions are a mix between the two sources. This result has implications for the daily total emissions measurements, which are performed primarily during the afternoons, when the ratio of road transit emissions to fixed combustion sources is at a maximum, as represented by the CO/CO₂ ratio. This ratio is well characterized diurnally, but additional information is needed to derive a diurnal pattern for the total emissions. The daytime CO/CO₂ ratio is lower during daytime hours after the WEF than it is before. Note that the temperatures were significantly lower after the WEF than before, by CCC′C. The observed ratios are consistent with the idea that the emissions from heating were higher after the WEF. During the WEF, the ratios are lower than before the WEF, despite the fact that the temperatures were similar. This may indicate that the drop in emissions during the WEF may be due to a reduction in traffic emissions, at least in part.

Discussion

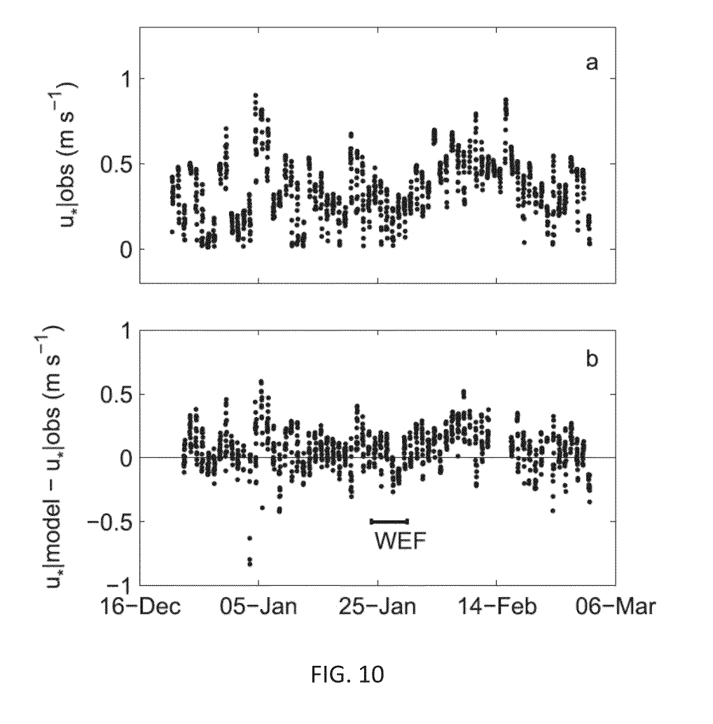

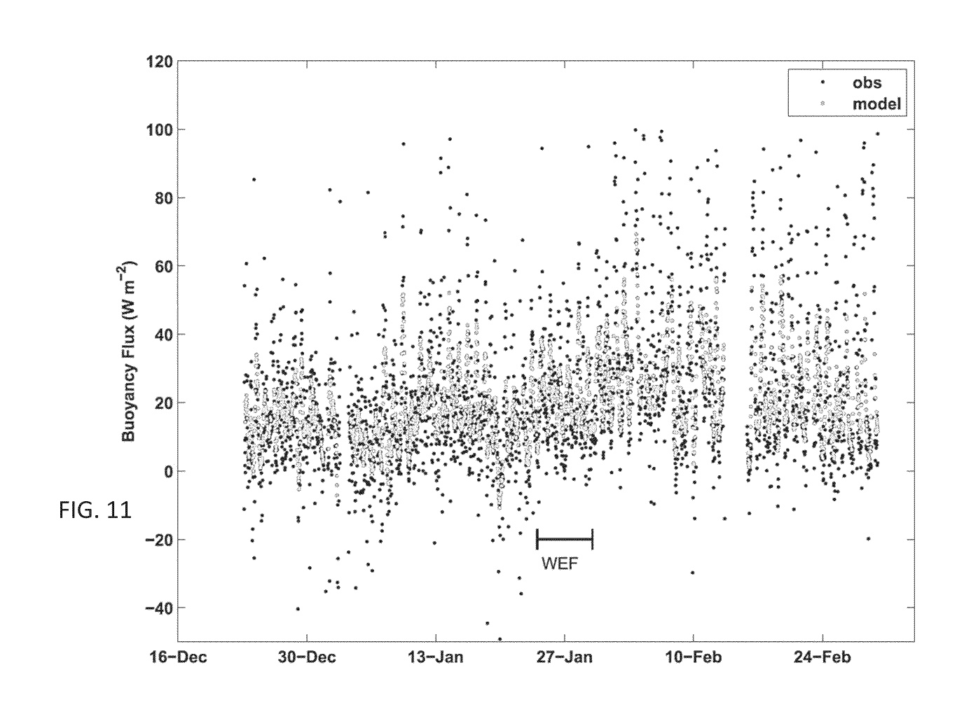

This first attempt to monitor daily emissions over a small-sized city using a top-down approach captured two pieces of information: large day-to-day variability and weather-related events over several days. However, the region is challenging for current mesoscale models, mainly because of the steep topography and the stability conditions at high altitudes during winter in the Alps (snow on the ground, low temperatures, and local atmospheric dynamics). For these reasons, systematic errors may affect the atmospheric transport, especially the representation of the vertical mixing under stable or neutral conditions with low turbulent surface fluxes, driven primarily by temperature at the surface and wind shear in the valley. To evaluate the model errors, a flux site was deployed, including a 3D sonic anemometer, to measure the friction velocity and the buoyancy flux in the valley of Davos and to quantify the modeling performance during the campaign. FIG. 10 shows the modeled and observed friction velocity at the downtown site over the campaign whereas FIG. 11 shows the buoyancy flux in watts per square meter. In particular, FIG. 10 shows observed (a) and observed minus modeled friction wind velocity (modeled at 1.33-km resolution by the WRF-FDDA modeling system) at the surface over the campaign (m s⁻¹) and FIG. 11 shows observed (dark) and simulated (light) buoyancy fluxes at 1.33-km resolution by the WRF-FDDA modeling system over the campaign (Wm⁻²).

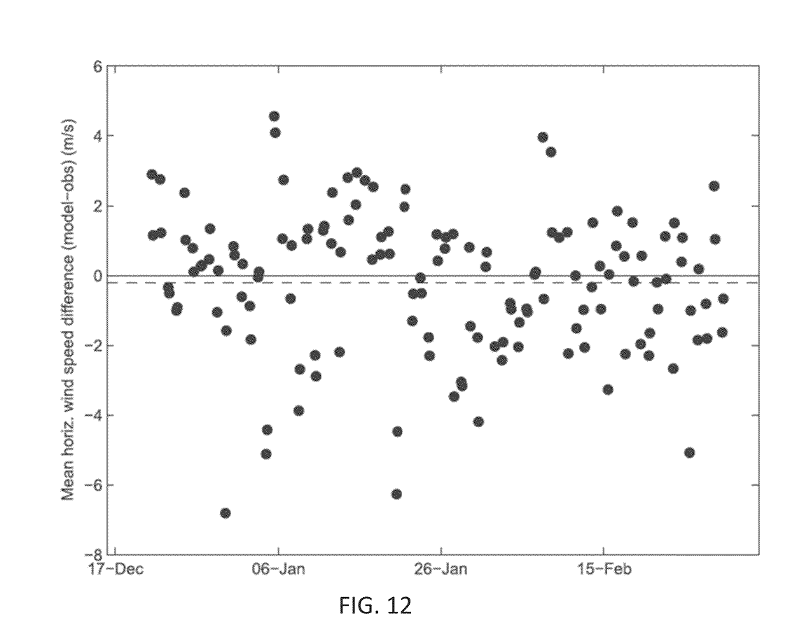

Considering the friction velocity, two periods reveal larger mismatch around 5 January and during the cold wave in early February. In both cases, the WRF model overestimated the vertical mixing, which suggests that the emissions could be overestimated during these periods. The inverse estimates may increase because of the lower modeled mixing ratios (dilution errors in the PBL). Overall, the friction velocity model-data mismatch is 0.07 6 0.16 m s⁻¹ between 1200 and 1700 LT over the campaign. The buoyancy flux is low over the period, from 10 to 40 W m⁻² for most days during the deployment period. The mean horizontal wind speed is presented in FIG. 12. In particular, FIG. 12 shows the mean horizontal wind speed differences (modeled minus observed) at 1.33-km resolution by the WRF-FDDA modeling system over the campaign (m s21). The dashed line indicates the mean difference over the period (−0.21 m s⁻¹). The mean difference is low over the period (−0.21 m s⁻¹) with a standard deviation of −2.1 m s⁻¹. The WRF-FDDA model was able to capture the observed daily variability with no systematic over- or underestimation of both the buoyancy flux and the mean horizontal wind speed on average over the period. The observed buoyancy flux shows a larger variability because of remaining turbulent structures measured at high frequency.

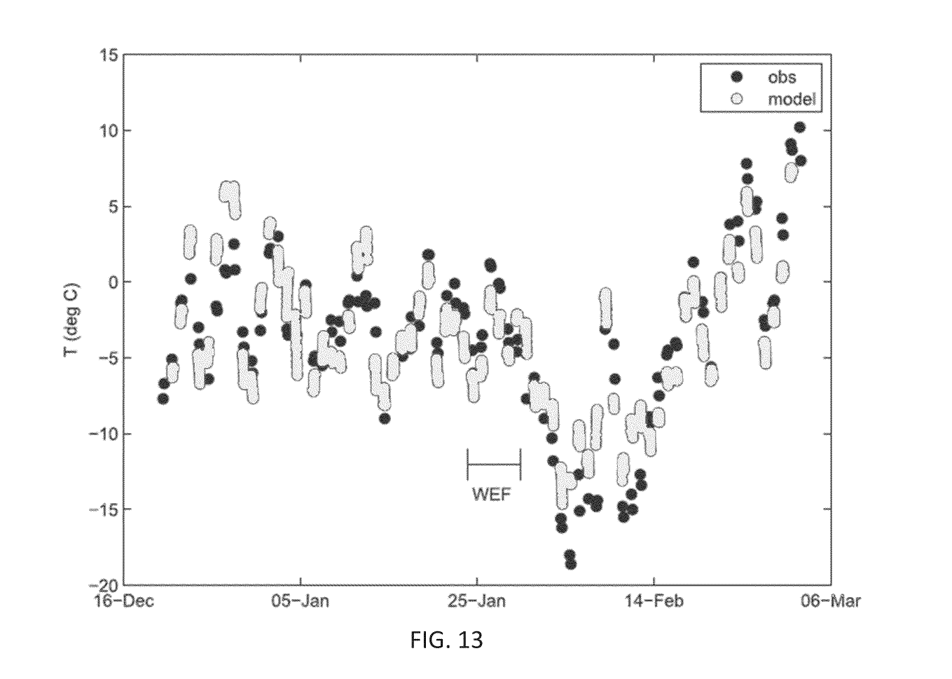

FIG. 13 shows observed (dark) and simulated (light) potential temperatures at 1.33-km resolution by the WRF-FDDA modeling system at the 2-m elevation over the campaign (° C.). The temperature at 2 m shown in FIG. 13 was also overestimated in early February, contributing directly to the buoyancy term in the surface energy budget by an excess of mixing due to heat transfer. On average, the temperature shows a low bias (0.8° C.) and a standard deviation of 2.4° C. As a comparison, the wind speed in the valley does not show any positive bias during the same period (see FIG. 11) and agrees with the measured wind speed, with an averaged model-data mismatch of 0.2±2.0 m s⁻¹. However, only a portion of the cold wave period is affected by positive model-data mismatch. This suggests that even though the average daily emissions during the cold wave may be overestimated for 5 days, the previous and following days seem consistent and should provide reasonable flux estimates.

Considering the WEF-2012 meeting period, the WRF model shows low model-data mismatch for the friction velocity, the buoyancy flux, and the 2-m temperature. The month of January exhibits an RMS of 0.17 m s⁻¹ and a mean of 0.4 m s⁻¹ in model-data mismatch of friction velocity, with no significant difference during the WEF-2012 meeting. It suggests that the decrease of the emissions during the WEF-2012 meeting relative to the emissions over the entire month of January is not due to biases in the vertical mixing. The model-data mismatch for the buoyancy flux has a mean of −0.32 W m⁻² over the period and the RMS is about 12.6 W m⁻², showing no systematic differences over the period (see FIG. 11). However, the low vertical mixing could induce a limited extent of the concentration footprint of the downtown site, which means that the estimated daily emissions may not represent the entire city of Davos. It seems unlikely that the concentration footprints are much smaller than 6 km², whereas footprints from Lagrangian particle dispersion models cover several tenths of square kilometers even in stable conditions.

The diurnal cycle composite of the CO/CO₂ ratio that corresponds to the contributions of house heating and traffic is consistent with previous studies in urban environments. The CO/CO₂ ratio showed clear evidence of changes in source contributions, between the traffic and the house heating components. Considering that the CO/CO₂ ratio decreased during the WEF-2012 meeting, the decrease in the emissions may be related to a decrease in traffic emissions in the area. Because of the lack of available information about traffic intensity during the meeting, this assumption remains valid but cannot be confirmed.

In addition, the daily estimates were performed using different threshold values of friction velocity, to assure the well-mixed criteria and better modeling performance. Despite removing several days of observations over the campaign based on the threshold values for the friction velocity (e.g., >0.3 m s⁻¹), the observed variability in emissions remained unchanged, that is, an increase during the cold wave event in early February and a decrease after the cold wave. The presence of a heliport during the WEF-2012 meeting may impact the stability conditions in the valley, with an increased entrainment of air from the free troposphere into the PBL. The vertical mixing due to helicopters taking off near the city may explain part of the apparent decrease in emissions.

The campaign deployment and the daily emission estimates provided several insights to emissions at very finescale and high temporal resolution. For the first time, a large-scale event in a limited-size city was monitored in real time. The decrease in emissions seems counterintuitive at the first order and raised several questions and concerns about the capability of the present inverse system. However, the evaluation of the modeling system and the use of CO as an additional tracer for fossil fuel emissions seem in agreement with the observed decrease of the emissions during the WEF-2012 meeting. The increase during the cold wave showed that major changes can be detected by our system and was confirmed by the observed lower CO/CO₂ ratios. Still, several limitations remain, such as the size of the concentration footprints in stable conditions or the potential changes in fossil fuel sources (e.g., closure of public places located in the city for the duration of the WEF-2012 meeting). The proximity of the background site, which may be impacted by emissions from Davos in the afternoon (uplift of air from the valley as indicated by elevated CO concentrations) or by air masses coming from other cities in the area, may affect our emission estimates. A second background site may have helped to identify CO2 air masses from other valleys, but other observations tend to indicate that changes in the economic activity level may explain the observed decrease with limited traffic around the city because of security measures. Finally, no clear evidence contradicts our current findings, that is, model errors or CO/CO2 ratios, but further investigations would be needed to confirm the causes of the decrease during the WEF-2012 meeting, including external information on the traffic and additional measurement locations to cross evaluate the present findings.

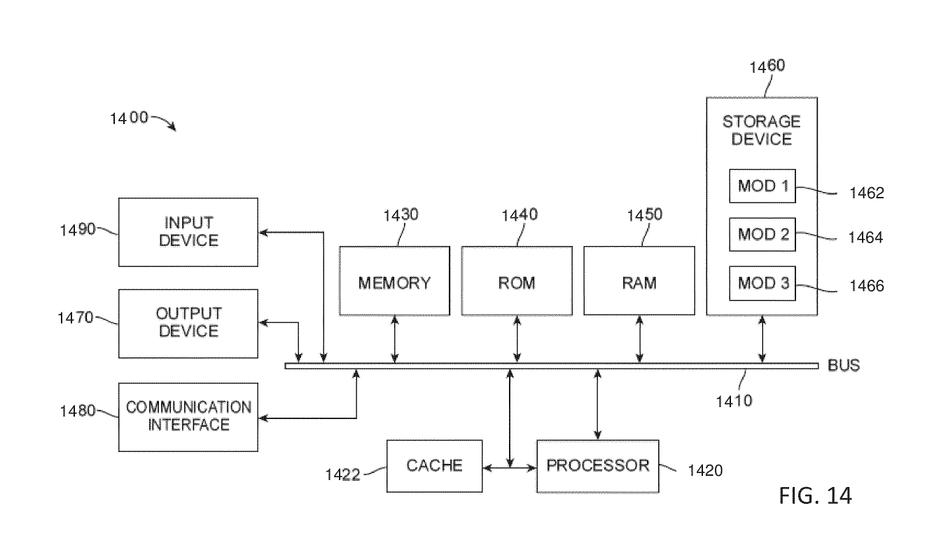

Various embodiments of the present technology are carried out using one or more computing device. With reference to FIG. 14, an exemplary system 1400 includes a general-purpose computing device 1400; including a processing unit (CPU or processor) 1420 and a system bus 1414 that couples various system components including the system memory 1430 such as read only memory (ROM) 1440 and random access memory (RAM) 1450 to the processor 1420. The system 1400 can include a cache 1422 of high speed memory connected directly with, in close proximity to, or integrated as part of the processor 1420. The system 1400 copies data from the memory 1430, and/or the storage device 1460, to the cache 1422 for quick access by the processor 1420. In this way, the cache provides a performance boost that avoids processor 1420 delays while waiting for data. These and other modules can control or be configured to control the processor 1420 to perform various actions. Other system memory 1430 may be available for use as well. The memory 1430 can include multiple different types of memory with different performance characteristics. It can be appreciated that the disclosure may operate on a computing device 1400 with more than one processor 1420 or on a group or cluster of computing devices networked together to provide greater processing capability. The processor 1420 can include any general purpose processor and a hardware module or software module, such as module 14 1462, module 2 1464, and module 3 1466 stored in storage device 1460, configured to control the processor 1420 as well as a special-purpose processor where software instructions are incorporated into the actual processor design. The processor 1420 may essentially be a completely self-contained computing system, containing multiple cores or processors, a bus, memory controller, cache, etc. A multi-core processor may be symmetric or asymmetric.

The system bus 1414 may be any of several types of bus structures including a memory bus or memory controller, a peripheral bus, and a local bus using any of a variety of bus architectures. A basic input/output (BIOS) stored in ROM 1440 or the like, may provide the basic routine that helps to transfer information between elements within the computing device 1400, such as during start-up. The computing device 1400 further includes storage devices 1460 such as a hard disk drive, a magnetic disk drive, an optical disk drive, tape drive or the like. The storage device 1460 can include software modules 1462, 1464, 1466 for controlling the processor 1420. Other hardware or software modules are contemplated. The storage device 1460 is connected to the system bus 1414 by a drive interface. The drives and the associated computer readable storage media provide nonvolatile storage of computer readable instructions, data structures, program modules and other data for the computing device 1400. In one aspect, a hardware module that performs a particular function includes the software component stored in a non-transitory computer-readable medium in connection with the necessary hardware components, such as the processor 1420, bus 1414, display 1470, and so forth, to carry out the function. The basic components are known to those of skill in the art and appropriate variations are contemplated depending on the type of device, such as whether the device 1400 is a small, handheld computing device, a desktop computer, or a computer server.

Although the exemplary embodiment described herein employs the hard disk 1460, it should be appreciated by those skilled in the art that other types of computer readable media which can store data that are accessible by a computer, such as magnetic cassettes, flash memory cards, digital versatile disks, cartridges, random access memories (RAMs) 1450, read only memory (ROM) 1440, a cable or wireless signal containing a bit stream and the like, may also be used in the exemplary operating environment. Non-transitory computer-readable storage media expressly exclude media such as energy, carrier signals, electromagnetic waves, and signals per se.

To enable user interaction with the computing device 1400, an input device 1490 represents any number of input mechanisms, such as a microphone for speech, a touch-sensitive screen for gesture or graphical input, keyboard, mouse, motion input, speech and so forth. An output device 1470 can also be one or more of a number of output mechanisms known to those of skill in the art. In some instances, multimodal systems enable a user to provide multiple types of input to communicate with the computing device 1400. The communications interface 1480 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 1420. The functions these blocks represent may be provided through the use of either shared or dedicated hardware, including, but not limited to, hardware capable of executing software and hardware, such as a processor 1420, that is purpose-built to operate as an equivalent to software executing on a general purpose processor. For example, the functions of one or more processors presented in FIG. 14 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 1440 for storing software performing the operations discussed below, and random access memory (RAM) 1450 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 1400 shown in FIG. 14 can practice all or part of the recited methods, can be a part of the recited systems, and/or can operate according to instructions in the recited non-transitory computer-readable storage media. Such logical operations can be implemented as modules configured to control the processor 1420 to perform particular functions according to the programming of the module. For example, FIG. 14 illustrates three modules Mod1 1462, Mod2 1464 and Mod3 1466, which are modules configured to control the processor 1420. These modules may be stored on the storage device 1460 and loaded into RAM 1450 or memory 1430 at runtime or may be stored as would be known in the art in other computer-readable memory locations.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

What is claimed is:

1. A method for estimating temporal changes in trace gas fluxes associated with trace gas modifier, comprising:
obtaining measurement amounts of one or more trace gases for a plurality of measurement sites in a region associated with the modifier for a length of time;
computing modeled amounts of the trace gases at the plurality of measurement sites during the length of time based on an atmospheric transport model and one or more prior estimates of a flux of the trace gases from the modifier;
identifying corresponding portions of the measurement amounts and the modeled amounts associated with at least one time period from the length of time during which the measured difference in the amount of the trace gases between the plurality of measurement sites are predicted to be primarily due to the flux of the trace gases from the modifier; and
selecting as a current estimate of the flux of the trace gases from the modifier one of the prior estimates associated with a difference between the corresponding portions of the measurement amounts and the modeled amounts meeting a criteria.

2. The method of claim 1, wherein the one or more prior estimates comprise a plurality of prior estimates, and wherein the selecting further comprises selecting as the current estimate a one of the plurality of prior estimates for which the difference is smallest.

3. The method of claim 1, wherein the selecting comprises selecting the current estimate to be any one of the one or more prior estimates for which the difference is less than a threshold difference.

4. The method of claim 3, wherein the selecting further comprises:
responsive to none of the prior estimates resulting in a difference less than a threshold difference, repeating the computing, identifying, and selecting for at least one additional prior estimate of the flux of the trace gases from the modifier.

5. The method of claim 1, wherein the identifying further comprises selecting the at least one period of time to correspond to a period of time for which atmospheric transport for the region can be simulated with a minimum degree of confidence.

6. The method of claim 1, wherein the measurement amounts and the modeled amounts correspond to amounts of the trace gases associated a plurality of different times of a day.

7. The method of claim 1, wherein the measurement amounts and the modeled amounts are selected to comprise a mixing ratio of the trace gases.

8. The method of claim 1, wherein the trace gases are selected to comprise at least one of CO, CO₂, or CH₄.

9. The method of claim 1, comprising:
repeating the steps of obtaining computing, identifying, and selecting for different portions of a period of time of interest;
combining the current estimate from the different portions to obtain a temporary variability of the flux of the trace gases from the modifier for the period of time of interest.

10. The method of claim 1, further comprising converting the current estimate to an actual measurement of the flux.

11. A system for estimating temporal changes in trace gas fluxes associated with trace gas modifier, comprising:
a processor;
a computer-readable medium having stored thereon a plurality of instructions for causing the processor to perform the method comprising:
obtaining measurement amounts of one or more trace gases for a plurality of measurement sites in a region associated with the modifier for a length of time,
computing modeled amounts of the trace gases at the plurality of measurement sites during the length of time based on an atmospheric transport model and one or more prior estimates of a flux of the trace gases from the modifier,
identifying corresponding portions of the measurement amounts and the modeled amounts associated with at least one time period from the length of time during which the measured difference in the amount of the trace gases between the plurality of measurement sites are predicted to be primarily due to the flux of the trace gases from the modifier; and
selecting as a current estimate of the flux of the trace gases from the modifier a one of prior estimates associated with a difference between the corresponding portions of the measurement amounts and the modeled amounts meeting a criteria.

12. The system of claim 10, wherein the one or more prior estimates comprise a plurality of prior estimates, and wherein the current estimate is selected to be the one of the plurality of prior estimates for which the difference is smallest.

13. The system of claim 10, wherein the current estimate is selected to be any one of the one or more prior estimates for which the difference is less than a threshold difference.

14. The system of claim 13, wherein the selecting further comprises:
responsive to none of the prior estimates resulting in a difference less than a threshold difference, repeating the computing, identifying, and selecting for one or more additional prior estimates of the flux of the trace gases from the modifier.

15. The system of claim 10, wherein the identifying further comprises selecting the at least one period of time to correspond to a period of time for which atmospheric boundary conditions for the region can be simulated with a minimum degree of confidence.

16. The system of claim 10, wherein the measurement amounts and the modeled amounts correspond to amounts of the trace gases associated a plurality of different times of a day.

17. The system of claim 10, wherein the measurement amounts and the modeled amounts comprise a mixing ratio of the trace gases.

18. The system of claim 10, wherein the trace gases comprise at least one of CO, CO₂, or CH₄.

19. The system of claim 10, the method further comprising:
repeating the steps of obtaining computing, identifying, and selecting for different portions of a period of time of interest;
combining the current estimate from the different portions to obtain a temporary variability of the flux of the trace gases from the modifier for the period of time of interest.

20. The system of claim 10, further comprising converting the current estimate to an actual measurement of the flux.

21. A computer-readable medium having stored thereon a plurality of instructions for causing a computer to perform a method for estimating temporal changes in trace gas fluxes associated with trace gas modifier, the plurality of instructions comprising code sections for:
obtaining measurement amounts of one or more trace gases for a plurality of measurement sites in a region associated with the modifier for a length of time;
computing modeled amounts of the trace gases at the plurality of measurement sites during the length of time based on an atmospheric transport model and one or more prior estimates of a flux of the trace gases from the modifier;
identifying corresponding portions of the measurement amounts and the modeled amounts associated with at least one time period from the length of time during which the measured difference in the amount of the trace gases between the plurality of measurement sites are predicted to be primarily due to the flux of the trace gases from the modifier; and
selecting as a current estimate of the flux of the trace gases from the modifier a one of prior estimates associated with a difference between the corresponding portions of the measurement amounts and the modeled amounts meeting a criteria.

22. The computer-readable medium of claim 21, wherein the one or more prior estimates comprise a plurality of prior estimates, and wherein the code sections for the selecting further comprise code sections for selecting the current estimate to be the one of the plurality of prior estimates for which the difference is smallest.

23. The computer-readable medium of claim 21, wherein the code sections for the selecting further comprise code sections for selecting the current estimate to be any one of the one or more prior estimates for which the difference is less than a threshold difference.

24. The computer-readable medium of claim 23, wherein the code sections for the selecting further comprise code sections for:
responsive to none of the prior estimates resulting in a difference less than a threshold difference, repeating the computing, identifying, and selecting for one or more additional prior estimates of the flux of the trace gases from the modifier.

25. The computer-readable medium of claim 21, wherein the code sections for the identifying further comprise code sections for selecting the at least one period of time to correspond to a period of time for which atmospheric boundary conditions for the region can be simulated with a minimum degree of confidence.

26. The computer-readable medium of claim 21, wherein the measurement amounts and the modeled amounts correspond to amounts of the trace gases associated a plurality of different times of a day.

27. The computer-readable medium of claim 21, wherein the measurement amounts and the modeled amounts comprise a mixing ratio of the trace gases.

28. The computer-readable medium of claim 21, wherein the trace gases comprise at least one of CO, CO₂, or CH₄.

29. The computer-readable medium of claim 21, further comprising code sections for:
repeating the steps of obtaining computing, identifying, and selecting for different portions of a period of time of interest;
combining the current estimate from the different portions to obtain a temporary variability of the flux of the trace gases from the modifier for the period of time of interest.

30. The computer-readable medium of claim 21, further comprising code sections for converting the current estimate to an actual measurement of the flux.
